(19) United States
(12) Patent Application Publication
(10) Pub. No.: US 2026/0240259 A1
(43) Pub. Date: Aug. 20, 2026

(54) AEROSOL GENERATION DEVICE

(71) Applicant: JAPAN TOBACCO INC., Tokyo (JP)

(72) Inventors: Tatsunari AOYAMA, Sumida-ku, Tokyo (JP); Junji MINATO, Sumida-ku, Tokyo (JP); Tomoya UCHIBORI, Sumida-ku, Tokyo (JP)

(73) Assignee: JAPAN TOBACCO INC., Tokyo (JP)

(21) Appl. No.: 19/489,601

(22) PCT Filed: Jun. 29, 2023
(86) PCT No.: PCT/JP2023/024182

§ 371 Date: Dec. 3, 2025

(51) Int. Cl. A24F 40/57; A24F 40/10; A24F 40/20; A24F 40/60; A24F 40/90; G05F 1/56; H05B 1/02

(52) U.S. Cl. CPC A24F 40/57; A24F 40/10; A24F 40/20; A24F 40/60; A24F 40/90; H05B 1/0252; G05F 1/56

(57) ABSTRACT

An aerosol-generating device comprising a heating unit for heating an aerosol source, a first temperature sensor for measuring a temperature change at a measurement site associated with the heating by the heating unit, a first AD conversion circuit for converting an output voltage of the first temperature sensor into digital data, a second temperature sensor for measuring a temperature change of the heating unit, and a second AD conversion circuit for converting an output voltage of the second temperature sensor into digital data, wherein the first AD conversion circuit has a higher conversion accuracy than the second AD conversion circuit, and the second AD conversion circuit has a faster conversion speed than the first AD conversion circuit.

### TECHNICAL FIELD

The present invention relates to an aerosol-generating device.

### BACKGROUND ART

Aerosol-generating devices, which are portable electronic appliances, are equipped with various electronic components. For example, aerosol-generating devices are equipped with an MCU (=Micro Controller Unit), a memory, an AD (=Analog to Digital) conversion circuit, a sensor, a heater for heating, and an LED (=Light-Emitting Diode). Incidentally, a plurality of AD conversion circuits are installed for each voltage value and signal value to be converted.

### CITATION LIST

### Patent Literature

PTL 1: CN 211882197 U

PTL 2: CN 108802606 A

PTL 3: CN 209563498 U

### SUMMARY OF INVENTION

### Technical Problem

Successive approximation type AD conversion circuits, which are general-purpose AD conversion circuits, are used in aerosol-generating devices. Successive approximation-type AD conversion circuits are known as AD conversion circuits that have a good balance of conversion speed and conversion accuracy.

Now, in the case of an aerosol-generating device having a heating source for heating an aerosol source, conversion speed is important for temperature control of the heating unit itself, and conversion accuracy is important for monitoring the temperature around the heating unit.

The present disclosure takes account of the abovementioned problems, and provides an aerosol-generating device having both a high speed of controlling the temperature of the heating unit and a high accuracy of detecting the temperature of a measurement site.

### Solution to Problem

As one aspect of the present disclosure, there is provided an aerosol-generating device comprising a heating unit for heating an aerosol source, a first temperature sensor for measuring a temperature change at a measurement site associated with the heating by the heating unit, a first AD conversion circuit for converting an output voltage of the first temperature sensor into digital data, a second temperature sensor for measuring a temperature change of the heating unit, and a second AD conversion circuit for converting an output voltage of the second temperature sensor into digital data, wherein the first AD conversion circuit has a higher conversion accuracy than the second AD conversion circuit, and the second AD conversion circuit has a faster conversion speed than the first AD conversion circuit.

A sigma-delta type AD conversion circuit may be used as the first AD conversion circuit as referred to here, and a successive approximation type or pipeline type AD conversion circuit may be used as the second AD conversion circuit.

In addition, the first temperature sensor may operate with a reference voltage of the first AD conversion circuit as an operating power supply.

The first temperature sensor may have a non-linear temperature characteristic.

The first temperature sensor may measure a temperature around an enclosure or the heating unit, and the second temperature sensor may measure a temperature change of the heating unit based on a control sequence.

The first temperature sensor may measure a temperature around an enclosure or the heating unit, and the second temperature sensor may measure a temperature of the aerosol source.

A first constant voltage circuit for generating a reference voltage for the first AD conversion circuit, and a second constant voltage circuit for generating an operating power supply for a memory that records an operation log may additional be provided. It should be noted that, in this case, the potential of the operating power supply of the memory and the potential of the reference voltage are the same.

The aerosol source may be a solid.

The aerosol source may be a liquid.

### Advantageous Effects of Invention

According to one aspect of the present disclosure, it is possible to provide an aerosol-generating device having both a high speed of controlling the temperature of the heating unit and a high accuracy of detecting the temperature of a measurement site.

### BRIEF DESCRIPTION OF DRAWINGS

FIG. 1 is a diagram in which a front face side of an aerosol-generating device is viewed from diagonally above.

FIG. 2 is a diagram in which the front face side of the aerosol-generating device is viewed from diagonally below.

FIG. 3 is a diagram in which a main body device with a front panel removed is viewed from the front.

FIG. 4 is a diagram schematically showing the internal configuration of the main body device.

FIG. 5 is a diagram illustrating an example of a heating profile for use when the aerosol source is a solid.

FIG. 6 is a diagram schematically showing an electronic circuit used in Embodiment 1.

FIG. 7 is a diagram illustrating the internal configuration of an MCU and connection relationships with peripheral circuits.

FIG. 8 is a diagram illustrating an example of a heating profile for use when the aerosol source is a liquid.

### DESCRIPTION OF EMBODIMENTS

Embodiments relating to the present disclosure will now be described with reference to the drawings. In the drawings, identical parts are indicated by identical reference signs.

### Terms

An aerosol-generating device according to each embodiment is a form of electronic cigarette. In the following description, a substance generated by the aerosol-generating device will be referred to as an aerosol. An aerosol refers to a mixture of minute liquid or solid particles suspended in a gas, and air or another gas.

The embodiments describe aerosol-generating devices which generate the aerosol without associated burning.

Moreover, inhalation of the aerosol generated by the aerosol-generating device will also be referred to as a “puff”.

In each embodiment, an aerosol-generating device to which it is possible to attach a solid aerosol source is described. It should be noted that a container for accommodating the solid aerosol source will be referred to as both a “capsule” and a “stick-type substrate”, depending on the form of product. Capsules and stick-type substrates are consumables. Capsules and stick-type substrates therefore have fixed criteria for replacement.

### Embodiment 1

### Example of External Appearance

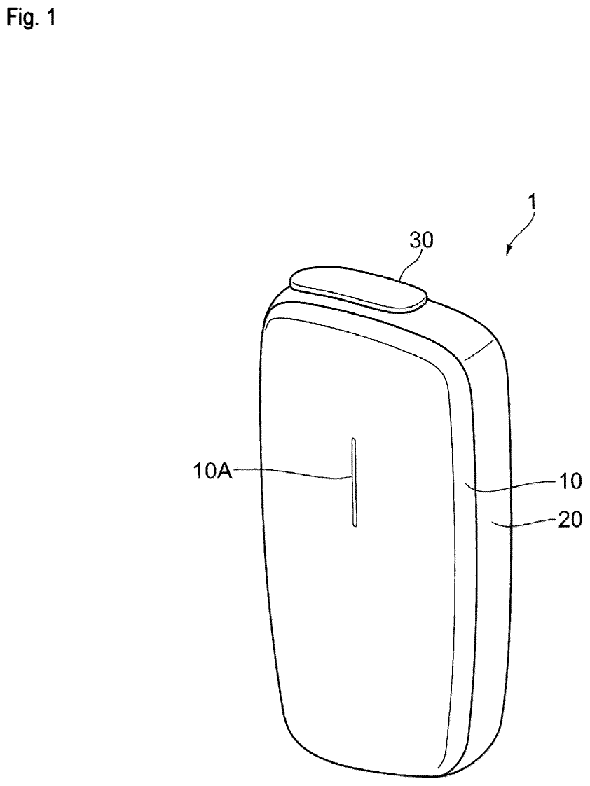

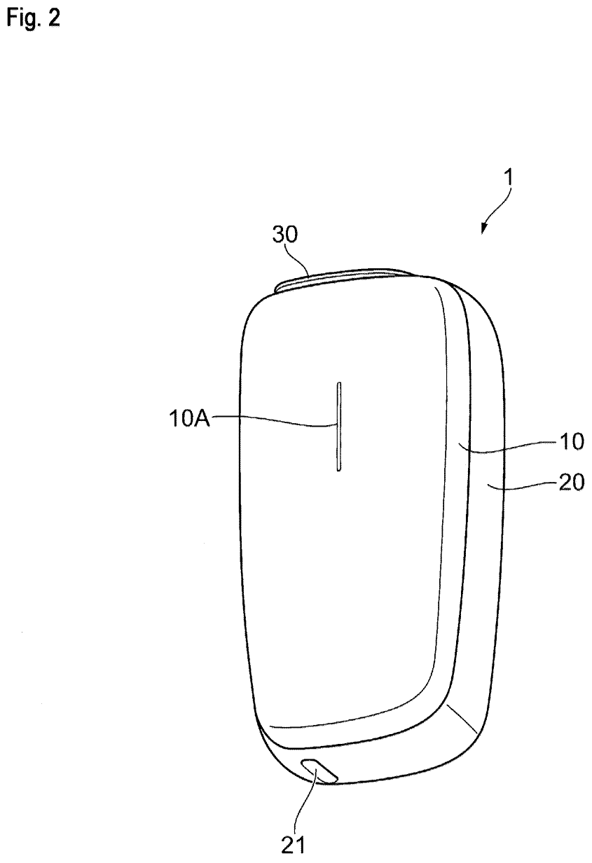

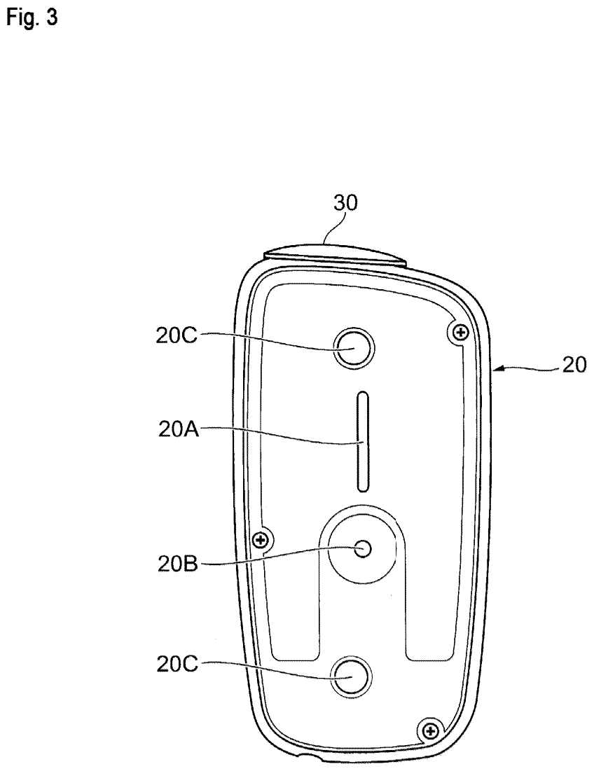

An example of the external appearance of an aerosol-generating device used in Embodiment 1 will first be described.
FIG. 1 is a diagram in which a front face side of an aerosol-generating device 1 is viewed from diagonally above.
FIG. 2 is a diagram in which the front face side of the aerosol-generating device 1 is viewed from diagonally below.
FIG. 3 is a diagram in which a main body device 20 with a front panel 10 removed is viewed from the front.

The aerosol-generating device 1 of this embodiment is sized to be capable of being held by a user in a single hand.

The aerosol-generating device 1 comprises a main body device 20, a front panel 10 which is mounted on the front of the main body device 20, and a shutter 30 which is disposed on an upper face of the main body device 20 and is capable of sliding along the upper face.

The front panel 10 is a member which is detachable from the main body device 20. Attachment and detachment of the front panel 10 is performed by the user.

The front panel 10 attached to the main body device 20 covers a front face part of the main body device 20, as shown in FIGS. 1 and 2. In other words, parts of the main body device 20 other than the front face part can also be seen from the outside after the front panel 10 has been attached. For example, side faces, a back face, an upper face, and a bottom face of the main body device 20 can also be seen from the outside after the front panel 10 has been attached.

The front panel 10 is provided with a window 10A. The window 10A is provided in a position facing a light-emitting element on the main body device 20 side. In Embodiment 1, LEDs (=Light-Emitting Diode) 20A are used as the light-emitting element. In Embodiment 1, eight LEDs 20A are provided in the main body device 20.

The window 10A in Embodiment 1 is formed by a light-transmissive material. However, the window 10A may equally be a slit that penetrates from a front surface to a rear surface.

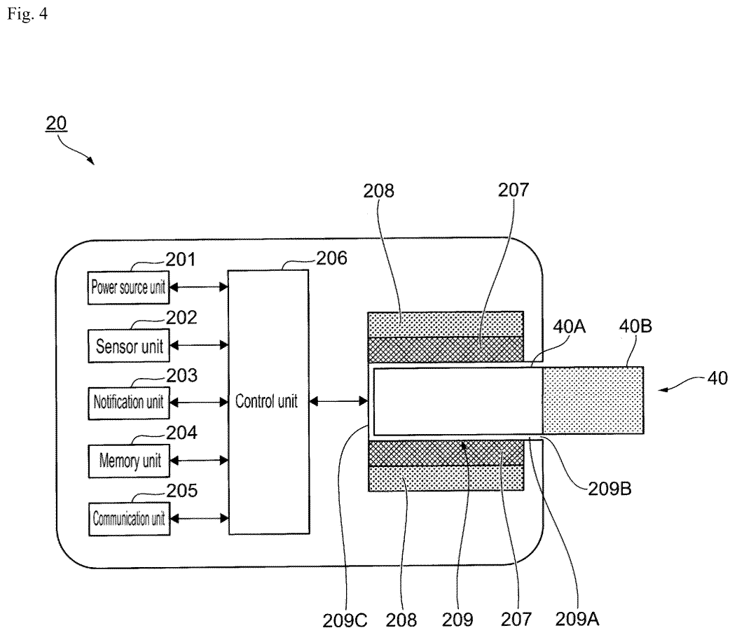

States of operation of the aerosol-generating device are assigned to patterns of illumination or flashing of the LEDs 20A. For example, states associated with heating of the aerosol source are assigned to illumination or flashing of the LEDs 20A. States associated with heating of the aerosol source include, for example, completion of preparation for heating of the aerosol source, start of heating, completion or termination of heating, number of aerosol sources available for inhalation, remaining time available for inhalation, and abnormality in the main body temperature. In addition, the occurrence of a failure or malfunction of the main body device 20, remaining battery capacity, charging or completion of charging, or pairing status, for example, are assigned to illumination or flashing of the LEDs 20A. Malfunctions as referred to here also include abnormalities relating to the ambient temperature. Illumination and flashing of the light-emitting element are controlled by a control unit 206 (see FIG. 4) which will be described later.

The front panel 10 also has the role of a buffer against the propagation of heat released from the main body device 20, etc. In the case of this embodiment, the generation of aerosol is permitted only when the front panel 10 is attached to the main body device 20.

The front panel 10 used in this embodiment deforms when a position below the window 10A is pressed by the user's fingertip, and the original shape is restored when the user stops pressing. This deformation allows a power button 20B provided in the main body device 20 to be operated while the front panel 10 remains attached to the main body device 20.

A type C USB (=universal serial bus) connector 21 is provided on the bottom face side of the main body device 20. The shape and type of USB connector 21 are given by way of example. In Embodiment 1, the USB connector 21 is used for charging a power source unit 201 (see FIG. 4) built into the main body device 20.

A hole (not shown) for insertion of a stick-type substrate 40 (see FIG. 4) accommodating an aerosol source is provided in an upper face portion of the main body device 20. The hole is exposed by sliding the shutter 30 to an open position, and is hidden by sliding the shutter 30 to a closed position.

The stick-type substrate 40 used in this embodiment has a structure in which a solid aerosol source is accommodated in a substantially cylindrical paper tube.

A magnet, for example, is attached to a rear face of the shutter 30. Meanwhile, a Hall IC is attached to the main body device 20 in a movable range of the shutter 30.

The Hall IC is a magnetic sensor formed by a Hall element and an operational amplifier, etc., and outputs a voltage corresponding to the intensity of a magnetic field passing across the Hall element.

In this embodiment, opening and closing of the shutter 30 is sensed from a change in the voltage output from the Hall IC accompanying sliding of the shutter 30. That is to say, it is sensed whether the shutter 30 is at the closed position or the open position.

As shown in FIG. 3, the power button 20B is disposed substantially in the center of the front face of the main body device 20. As indicated above, the power button 20B can be operated while the front panel 10 remains attached.

The power button 20B is used, for example, for turning the power source of the main body device on and off, for turning the power supply to a heating unit 207 (see FIG. 4) that heats the aerosol source on and off, and for Bluetooth (registered trademark) pairing commands, etc.

Moreover, a reset function is performed by a long press (e.g., a press of 5 seconds or more) on the power button 20B while the front panel 10 is removed from the main body device 20. BLE (=Bluetooth low energy) is used as Bluetooth in this embodiment.

As shown in FIG. 3, magnets 20C used for attaching the front panel 10 are disposed on the upper portion and lower portion of the front face of the main body device 20. The magnets 20C are provided in positions facing magnets (not shown) provided on the inner side of the front panel 10. If the magnets on the front panel 10 are N poles, for example, the magnets 20C on the main body device 20 side are S poles. The front panel 10 is detachably attached to the main body device 20 by the force of attraction of the magnets.

It should be noted that either the magnets on the front panel 10 side or the magnets 20C on the main body device 20 side may be metal pieces made of iron or another magnetic metal. Incidentally, attachment of the front panel 10 to the main body device 20 is sensed by means of the Hall IC provided on the main body device 20 side.

Various other types of electronic components required for generating an aerosol are built into the main body device 20. In Embodiment 1, a device configuration in which the front panel 10 is attached to the main body device 20 has been described as the aerosol-generating device 1, but in a narrow sense, the main body device 20 is referred to as an aerosol-generating device. internal configuration

FIG. 4 is a diagram schematically showing the internal configuration of the main body device 20. It should be noted that FIG. 4 shows a state in which the stick-type substrate 40 has been fitted into the main body device 20.

The internal configuration shown in FIG. 4 is used to illustrate the components provided in the main body device 20 and positional relationships therebetween. For this reason, the external appearance of the components, etc. shown in FIG. 4 does not always match the external views described above.

The main body device 20 is configured by the power source unit 201, a sensor unit 202, a notification unit 203, a memory unit 204, a communication unit 205, the control unit 206, the heating unit 207, a heat insulating portion 208, and a holding portion 209.

As described above, FIG. 4 depicts a state in which the stick-type substrate 40 is being held in the holding portion 209. The aerosol is inhaled by the user in this state.

The power source unit 201 is a unit for supplying power to each component. The power source unit 201 uses a secondary battery to store power required by the main body device 20. In Embodiment 1, a lithium ion secondary battery is used as the secondary battery, for example. The secondary battery can be charged from an external power source. In Embodiment 1, the external power source is supplied through the USB connector 21 (see FIG. 2).

In the following, power supplied from the secondary battery will be referred to as “VBAT” and power supplied via the USB connector 21 will be referred to as “VBUS”. The power supply VBUS is a 5 V power supply. It should be noted that it is also possible for a 5 V power supply to be generated from VBAT.

The sensor unit 202 is an electronic component for detecting various types of information relating to the main body device 20.

The sensor unit 202 includes a pressure sensor such as a microphone capacitor, or a flow rate sensor, for example. The sensor unit 202 outputs detected information to the control unit 206. For example, when a change in air pressure or a flow of air accompanying inhalation has been detected, the sensor unit 202 outputs a numerical value representing inhalation of the aerosol by the user to the control unit 206.

The sensor unit 202 is provided in conjunction with a button or switch used for receiving user operations, for example. The button as referred to here includes the power button 20B (see FIG. 3) described above. Furthermore, the switch includes the shutter 30 (see FIG. 1) described above. If a user operation is sensed, the sensor unit 202 outputs the sensing of the operation to the control unit 206.

The sensor unit 202 additionally includes a temperature sensor for detecting the temperature of the heating unit 207. The temperature sensor detects the temperature of the heating unit 207 on the basis of a change in an electrical resistance value of an electrically conductive track of the heating unit 207, for example. The temperature sensor outputs a voltage corresponding to the electrical resistance value at the current time. The control unit 206 calculates the temperature of the heating unit 207 from the output voltage from the temperature sensor. The temperature sensor is used for the purpose of varying the temperature of the heating unit 207 in accordance with a heating profile.

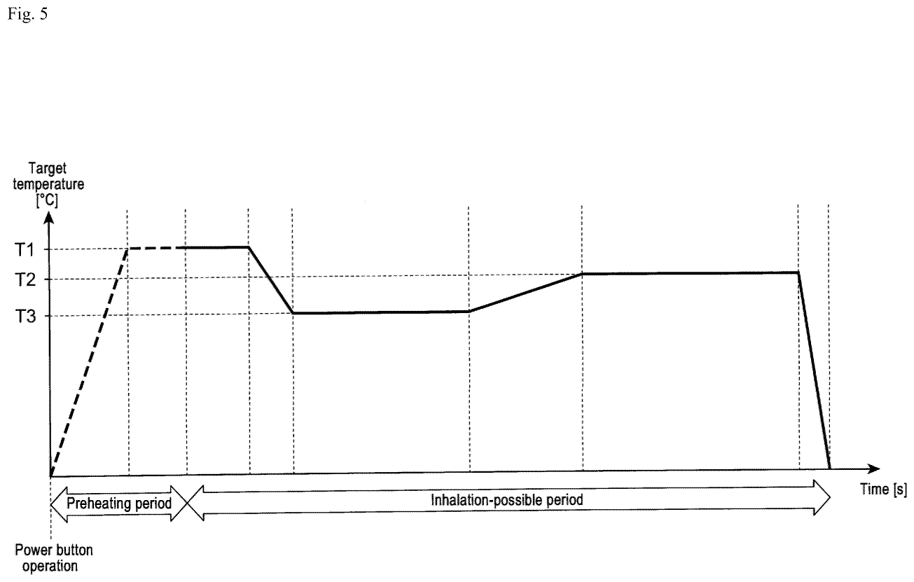

FIG. 5 is a diagram illustrating an example of a heating profile for use when the aerosol source is a solid. The horizontal axis represents elapsed time from the start of heating. The vertical axis represents target temperature. In the case of the heating profile shown in FIG. 5, a preheating period is provided before an inhalation-possible period. The preheating period corresponds to a preparation period for generating a sufficient amount of aerosol from the start of inhalation. This is because the temperature of the aerosol source before the start of heating by the heating unit 207 is the same as room temperature, and a sufficient amount of aerosol cannot be generated immediately after the power button has been operated. The target temperature of the heating unit 207 in the preheating period is T1. In this embodiment, the target temperature T1 is set to be the highest temperature over the entire time period.

It should be noted that maintaining the temperature of the heating portion 207 at the target temperature T1 even after the preheating period results not only in an excessive amount of aerosol generation, but also in an unstable amount of aerosol generation throughout the inhalation-possible period. Therefore, after the aerosol source has been sufficiently heated, the temperature of the heating unit 207 is reduced to a target temperature T3. In addition, in the latter half of the inhalation-possible period, the temperature of the heating unit 207 is raised to a target temperature T2 (>T3) so that the amount of aerosol generation is kept constant throughout the entire period. The heating profile is stored in the memory unit 204 as a data file defining the change over time in the target temperature after the start of heating.

The memory unit 204 stores one heating profile in this embodiment. However, it is also possible to arrange that a plurality of heating profiles can be stored. If a plurality of heating profiles can be stored, the heating profile to be used to heat the aerosol source is selected in advance. It should be noted that the heating profile will also be referred to as a “control profile” and a “control sequence”. Other temperature sensors include a temperature sensor for detecting the ambient temperature of the heating unit 207 and a temperature sensor for detecting the temperature near the surface of the main body device 20. These two temperature sensors are used from the viewpoint of detecting an unexpected increase in temperature. In other words, these temperature sensors are provided from the viewpoint of safety.

The notification unit 203 is an electronic component for notifying the user of various types of information relating to the main body device 20. The notification unit 203 includes the LEDs 20A (see FIG. 3), for example. Light emission or flashing of the LEDs 20A is controlled in patterns corresponding to the content of the notification. If multiple LEDs 20A having different light emission colors are provided, differences in the light emission color may be combined with light emission or flashing. For example, red may be used to notify a state in which use has been stopped or a repair is required, and white, green, blue, etc. may be used to notify a normal usage state.

The notification unit 203 may also include another device which is used together with the LEDs 20A or is used instead of the LEDs 20A. Other devices include display devices for displaying text, images and other information, sound output devices for outputting sound, and vibration devices for causing the main body device 20 to vibrate, etc.

Light-emitting devices, display devices, sound output devices, vibration devices, etc., are also used to notify the state of operation of the aerosol-generating device 1.

The memory unit 204 is an electronic component for storing various types of information relating to operation of the main body device 20. The memory unit 204 is configured by a non-volatile semiconductor storage medium such as a flash memory, for example.

Information stored in the memory unit 204 includes an OS (=operating system) and FW (=firmware), and other programs, for example.

Furthermore, the information stored in the memory unit 204 includes information relating to control of electronic components, for example. The information relating to control is information relating to inhalation by the user, such as number of inhalations, times at which inhalation has occurred, and cumulative inhalation time. This information is also referred to as an operation log.

The communication unit 205 is a communication interface for implementing communication between the main body device 20 and other devices. The communication unit 205 communicates with other devices by means of a system based on any wired or wireless communication standard. Examples of communication standards as referred to here include wireless LAN (=local area network), USB, Wi-Fi (registered trademark), and Bluetooth (registered trademark). For example, the communication unit 205 sends the information relating to user inhalation to a smartphone. Furthermore, the communication unit 205 downloads, from a server, update programs and heating profiles defining changes in the temperature of the heating unit 207 in a heating mode.

The control unit 206 functions as an arithmetic processing device and a control device, and controls operations of each part constituting the main body device 20 in accordance with various programs.

Control signals are sent through signal lines different from power supply lines. For example, communication in the main body device 20 employs a serial communication method such as an I2C (=inter-integrated circuit) communication method, an SPI (=serial peripheral interface) communication method, or a UART (=universal asynchronous receiver transmitter) communication method.

The control unit 206 is realized by means of an electronic circuit such as a CPU (=central processing unit), an MCU (=microcontroller unit), an MPU (=microprocessing unit), a GPU (=graphical processing unit), an ASIC (=application-specific integrated circuit), an FPGA (=field programmable gate array), or a DPS (=digital signal processor), for example. The control unit 206 may also include a ROM (=read only memory) for storing programs and computation parameters, etc., and a RAM (=random access memory) for temporarily storing suitably changing parameters, etc.

The control unit 206 executes various types of processing and control through execution of programs.

The processing and control referred to here include, for example: supply of electricity by the power source unit 201; charging of the power source unit 201; detection of information by the sensor unit 202; notification of information employing the notification unit 203; writing of information to the memory unit 204 or reading of information from the memory unit 204; and sending/receiving of information employing the communication unit 205.

The control unit 206 additionally controls processing, etc. based on input of information to the electronic components and information output from the electronic components.

The holding portion 209 is a substantially cylindrical container. In this embodiment, a space inside the holding portion 209 defined by an inner wall and a bottom face will be referred to as an internal space 209A. The internal space 209A is substantially columnar. The holding portion 209 as referred to here corresponds to the hole exposed by sliding of the shutter 30.

An opening 209B allowing the internal space 209A to communicate with the exterior is provided in the holding portion 209. The stick-type substrate 40 is inserted into the internal space 209A from the opening 209B. The stick-type substrate 40 is inserted until a tip end thereof touches a bottom portion 209C.

The stick-type substrate 40 is only partially accommodated in the internal space 209A. A state in which the stick-type substrate 40 is accommodated in the internal space 209A will be referred to as the stick-type substrate 40 being held in the internal space 209A.

The inner diameter of at least part of the holding portion 209 in an axial direction thereof is formed so as to be smaller than the outer diameter of the stick-type substrate 40.

An outer circumferential surface of the stick-type substrate 40 inserted into the internal space 209A is therefore subjected to pressure from the inner wall of the holding portion 209. The stick-type substrate 40 deforms and is held in the internal space 209A by means of this pressure.

The holding portion 209 also has a function of defining a flow path for air passing through the stick-type substrate 40. An air inflow hole, which is an inlet for air into the flow path, is disposed in the bottom portion 209C, for example. Moreover, the opening 209B serves as an air outflow hole, which is an outlet for the air.

In this embodiment, only part of the stick-type substrate 40 is held in the holding portion 209, with the remainder protruding outside from an enclosure. The part of the stick-type substrate 40 that is held in the holding portion 209 will be referred to below as a substrate portion 40A, and the part that protrudes from the enclosure will be referred to below as a mouthpiece portion 40B. The aerosol source is accommodated in at least the substrate portion 40A. The aerosol source is a substance which is atomized by heating so as to generate an aerosol.

The aerosol source includes shredded tobacco, and also processed products obtained by molding a tobacco raw material into a granular form, a sheet form or a powder form, or other tobacco-derived substances.

In addition, the aerosol source may also include non-tobacco-derived substances produced from plants other than tobacco, such as mint or herb. The aerosol source may include a flavoring component such as menthol, for example.

When the main body device 20 is a medical inhaler, the aerosol source may include a drug to be inhaled by a patient. It should be noted that the aerosol source is not limited to a solid, and may equally be a polyhydric alcohol such as glycerol or propylene glycol, or may be a liquid such as water, for example.

At least part of the mouthpiece portion 40B is held in the user's mouth during inhalation. When the user inhales with the mouthpiece portion 40B held in their mouth, air flows into the internal space 209A from the air inflow hole. The air that has flowed in reaches the user's mouth after passing through the internal space 209A and the substrate portion 40A. The air reaching the user's mouth contains the aerosol generated by the substrate portion 40A.

The heating unit 207 is formed by a heater or other heat-generating element. The heating unit 207 is formed by any material such as a metal or polyimide. The heating unit 207 is constructed in the form of a film, for example, and is fitted to the outer circumferential surface of the holding portion 209.

The aerosol source contained in the stick-type substrate 40 is heated and atomized by the heat generated by the heating unit 207. The atomized aerosol source is mixed with air, etc., and an aerosol is generated.

In FIG. 4, the outer circumferential region of the stick-type substrate 40 is initially heated, with the range of heating steadily moving toward the center.

Atomization of the aerosol source therefore starts from the outer circumferential region of the stick-type substrate 40 and steadily moves toward the center.

The heating unit 207 generates heat by means of electrical supply from the power source unit 201. Electrical supply to the heating unit 207 is permitted when a predetermined user operation has been detected by means of the sensor unit 202, for example. The predetermined user operation as referred to here includes an operation of the shutter 30 (see FIG. 1) or the power button 20B (see FIG. 3).

Moreover, inhalation by the user becomes possible when the temperature of the stick-type substrate 40 heated by means of the heating unit 207 reaches a predetermined temperature. A change over time in the target temperature from the start of heating to the end of heating is stored in the memory unit 204 as a heating profile. The heating profile is an example of a control sequence. Inhalation of the aerosol by the user is sensed by means of the flow rate sensor, etc. in the sensor unit 202 and is saved in the memory unit 204.

Electrical supply to the heating unit 207 is stopped when a predetermined time has elapsed since the start of heating or when a predetermined user operation is sensed. The predetermined operation is, for example, removal of the stick-type substrate 40.

Furthermore, in the example of FIG. 4, the heating unit 207 is disposed at the outer circumferential portion of the stick-type substrate 40, but the heating unit 207 may equally be a blade-like metal piece which is inserted into the stick-type substrate 40.

Alternatively, an induction heating method, for example, may be used to atomize the aerosol source. In this type of heating method, the heating unit 207 has at least an electromagnetic induction source such as a coil that generates a magnetic field. In this case, a susceptor is disposed at a position overlapping the magnetic field generated by the electromagnetic induction source. The susceptor generates heat in association with generation of the magnetic field, and heats the aerosol source. The susceptor may be a metal piece that is built into the stick-type substrate 40. When a metal piece acting as the heating unit 207 is built into the stick-type substrate 40, a coil for inductively heating the metal piece is disposed around the holding portion 209. Alternatively, the susceptor may be disposed at an outer circumferential portion of the stick-type substrate 40 within the main body device 20, and a coil serving as an electromagnetic induction source may be wound around the outer circumferential portion thereof.

The heat insulating portion 208 is a member for reducing propagation of heat generated by the heating unit 207 to the surrounding area. The heat insulating portion 208 is therefore disposed so as to cover at least the outer circumferential surface of the heating unit 207.

For example, the heat insulating portion 208 is configured by a vacuum insulating material or an aerogel insulating material, etc. A vacuum insulating material is a heat insulating material in which a state of high vacuum is created by wrapping glass wool and silica (silicon powder), etc. in a resin film, for example, so that heat conduction by gas is as close as possible to zero.

### Outline Configuration of Electronic Circuit

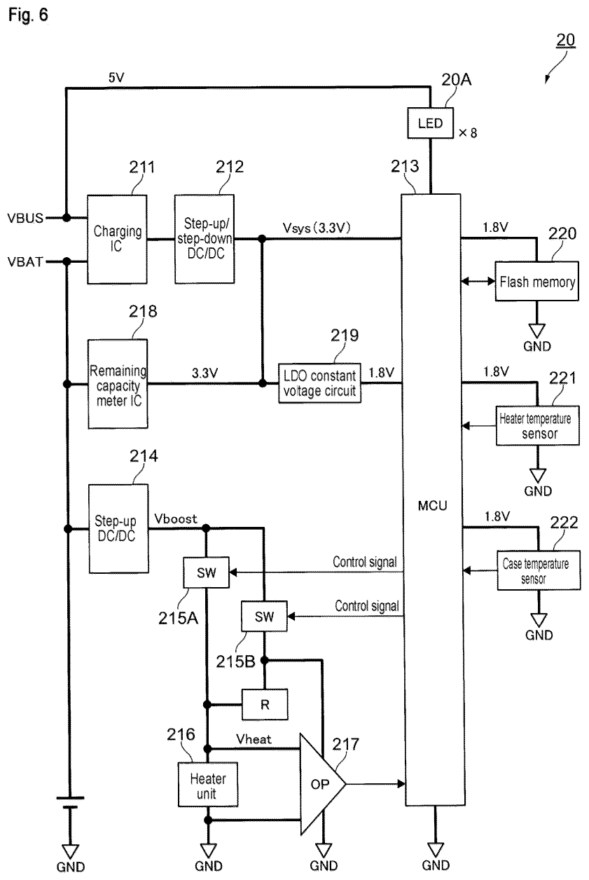

FIG. 6 is a diagram schematically showing an electronic circuit used in Embodiment 1. FIG. 6 shows connection relationships between typical components. It should be noted that in FIG. 6, wiring used for power supply (referred to below as “power supply lines”) is shown by thick lines, and wiring used for control, etc. (referred to below as “signal lines”) is shown by thin lines.

The electronic circuit shown in FIG. 6 comprises a charging IC 211, a step-up/step-down DC/DC circuit 212, an MCU 213, a step-up DC/DC circuit 214, a heater switch 215A, a resistance value measurement switch 215B, a heater unit 216, an operational amplifier 217, a remaining capacity meter IC 218, an LDO (=Low Dropout) constant voltage circuit 219, a flash memory 220, a heater temperature sensor 221, a case temperature sensor 222, and LEDs 20A.

The charging IC 211 is an electronic circuit that switches a power supply path. For example, when a USB cable is connected to the USB connector 21 (see FIG. 2), the charging IC 211 connects the power supply VBUS to the step-up/step-down DC/DC circuit 212 and the power supply VBAT.

In contrast, when a USB cable is not connected to the USB connector 21, the charging IC 211 connects the power supply VBAT to the step-up/step-down DC/DC circuit 212.

The charging IC 211 senses whether or not a USB cable is connected to the USB connector 21, and switches the power supply path depending on the detection result.

When the LEDs 20A are to be illuminated without a USB cable being connected, the charging IC 211 generates a 5 V power supply by OTG (=On-The-Go) and applies this to the power supply line for the LEDs 20A.

The step-up/step-down DC/DC circuit 212 is a circuit that converts the power supply VBUS or the power supply VBAT supplied from the charging IC 211 into a system power supply Vsys having a constant voltage. The system power supply Vsys is 3.3 V in this embodiment. In the case of FIG. 6, the system power supply Vsys is supplied to the MCU 213, the remaining capacity meter IC 218 and the LDO constant voltage circuit 219.

For example, when the power supply VBAT is being supplied, the step-up/step-down DC/DC circuit 212 generates the system power supply Vsys by stepping up or stepping down the power supply VBAT. The power supply VBAT varies depending on the remaining capacity and the degree of degradation of the secondary battery, but is converted to a constant voltage by the step-up/step-down DC/DC circuit 212.

Meanwhile, when a voltage derived from the power supply VBUS (that is, a 5 V power supply) is supplied, the step-up/step-down DC/DC circuit 212 steps down the supplied voltage to generate the system power supply Vsys.

The MCU 213 is an example of the control unit 206 (see FIG. 4) for controlling the operation of each unit constituting the aerosol-generating device 1 (see FIG. 1), and is operated using the system power supply Vsys.

The MCU 213 comprises a plurality of electronic components. For example, the MCU 213 consists of an AD conversion circuit for converting an analog signal input from an input terminal into digital data, an LDO constant voltage circuit for generating various power supplies, and a field effect transistor (FET) for controlling the operation of external elements (for example, the LEDs 20A).

The MCU 213 has a function of detecting a temperature using the case temperature sensor 222 before the heater unit 216 starts heating the stick-type substrate 40 (see FIG. 4), and preventing the heater unit 216 from starting to heat the stick-type substrate 40 if the detected temperature exceeds a threshold.

An upper limit temperature and a lower limit temperature of the operating environmental temperature, for example, may be used as the threshold as referred to here, or an upper limit value of temperature permitted at the measurement site may be used.

The step-up DC/DC circuit 214 is a circuit that converts the power supply VBAT supplied from the secondary battery into a boost power supply Vboost having a constant voltage. The boost power supply Vboost is a power supply having a higher potential than the system power supply. The boost power supply Vboost is 5 V, for example. In the case of FIG. 6, the 5 V power supply supplied to the LEDs 20A and the boost power supply Vboost supplied to the heater unit 216 are wired separately for the purpose of load distribution.

The heater switch 215A is a switch for controlling application of the boost power supply Vboost to the heater unit 216, and is configured by an FET, for example. In this embodiment, opening and closing of the heater switch 215A is PWM (=Pulse Width Modulation) controlled by the MCU 213.

The temperature of the heater unit 216 is controlled to match the heating profile by means of the PWM control of the heater switch 215A.

Incidentally, the heating profile comprises data for providing a target temperature depending on elapsed time, and is stored in the memory unit 204 (see FIG. 4).

Control for opening and closing the heater switch 215A may be initiated by sensing predetermined user input, for example input from the power button 20B (see FIG. 3).

The resistance value measurement switch 215B is a switch that is controlled to be open when the resistance value of the heater unit 216 is to be sensed, and is controlled to be closed during periods when the resistance value is not being sensed, and is configured, for example, by an FET. Opening and closing of the resistance value measurement switch 215B is also controlled by the MCU 213. The resistance value measurement switch 215B is controlled to close when the heater switch 215A is in the open state. When the resistance value measurement switch 215B is controlled to be closed, the boost power supply Vboost is applied to the operational amplifier 217. Furthermore, a resistor R is connected in series with the heater unit 216.

As a result, a voltage Vheat is apparent at a connection midpoint between the resistor R and the heater unit 216, the voltage Vheat being a voltage obtained by dividing the boost power supply Vboost according to a ratio of the resistance value of the resistor R to the resistance value of the heater unit 216 (i.e., the resistance ratio).

The heater unit 216 is an example of the heating unit 207 that generates heat when energized and heats the stick-type substrate 40 that has been inserted into the holding portion 209. The resistance value of the heater unit 216 varies depending on the temperature of the heater unit 216. For example, as the temperature increases, the resistance value of the heater unit 216 increases. As a result, the higher the temperature of the heater unit 216, the higher the potential of the voltage Vheat.

The operational amplifier 217 is a circuit that detects the resistance value of the heater unit 216. In this embodiment, the operational amplifier 217 uses the boost power supply Vboost as an operating power supply. As described above, supply of the boost power supply Vboost to the operational amplifier 217 is limited to a timing at which the voltage Vheat corresponding to the resistance value of the heater unit 216 is detected.

The operational amplifier 217 outputs a voltage corresponding to the voltage Vheat, input to the non-inverting input terminal, to the MCU 213. The MCU 213 measures the change in temperature of the heater unit 216 by way of this voltage. In the present embodiment, the operational amplifier 217 that detects the voltage Vheat is an example of the second temperature sensor.

The remaining capacity meter IC 218 is an electronic component that operates using the system power supply Vsys as an operating power supply and that calculates and stores the SOH (=State of Health), SOC (=State of Charge), full charge capacity, and remaining capacity of the secondary battery by monitoring the power supply VBAT. Moreover, the remaining capacity meter IC 218 notifies the MCU 213 of information such as the calculated SOH by I2C communication.

The LDO constant voltage circuit 219 is a power supply circuit that generates a predetermined voltage from the system power supply Vsys. In the case of FIG. 6, the LDO constant voltage circuit 219 outputs 1.8 V.

The flash memory 220 is a non-volatile semiconductor memory that stores firmware and operation logs, and is an example of the memory unit 204. In the case of FIG. 6, the operating power supply potential of the flash memory 220 is 1.8 V. It should be noted that SPI communication is used for communication between the flash memory 220 and the MCU 213.

The heater temperature sensor 221 is a temperature sensor that measures the temperature around the heater unit 216. The heater temperature sensor 221 is provided for the purpose of sensing abnormal heat generation. In other words, it is provided from the viewpoint of safety.

In this embodiment, a thermistor is used as the heater temperature sensor 221. A thermistor is a temperature sensor having a resistance value that changes significantly with respect to a change in temperature. A thermistor is a temperature sensor having a non-linear temperature characteristic. It should be noted that the heater temperature sensor 211 is an example of the first temperature sensor.

The power supply voltage of the heater temperature sensor 221 shown in FIG. 6 is 1.8 V. In this embodiment, the potential of the power supply voltage supplied to the heater temperature sensor 221 is the same as the potential of the power supply voltage supplied to the flash memory 220. It should be noted that the potential of the power supply voltage supplied to the flash memory 220 and the potential of the power supply voltage supplied to the heater temperature sensor 221 do not need to be 1.8 V, and do not need to be the same either.

An output voltage representing the temperature of the measurement site is provided from the heater temperature sensor 221 to the MCU 213.

The case temperature sensor 222 is a temperature sensor that measures the temperature near a surface of the main body device 20. The case temperature sensor 222 is also provided for the purpose of sensing abnormal heat generation. In other words, the case temperature sensor 222 is provided from the viewpoint of safety.

In this embodiment, a thermistor is used as the case temperature sensor 222. The case temperature sensor 222 is also an example of the first temperature sensor.

The power supply voltage of the case temperature sensor 222 shown in FIG. 6 is 1.8 V. In this embodiment, the potential of the power supply voltage supplied to the case temperature sensor 222 is the same as the potential of the power supply voltage supplied to the flash memory 220. It should be noted that the potential of the power supply voltage supplied to the flash memory 220 and the potential of the power supply voltage supplied to the case temperature sensor 222 do not need to be 1.8 V, and do not need to be the same either.

An output voltage representing the temperature of the measurement site is provided from the case temperature sensor 222 to the MCU 213.

### Internal Configuration of MCU

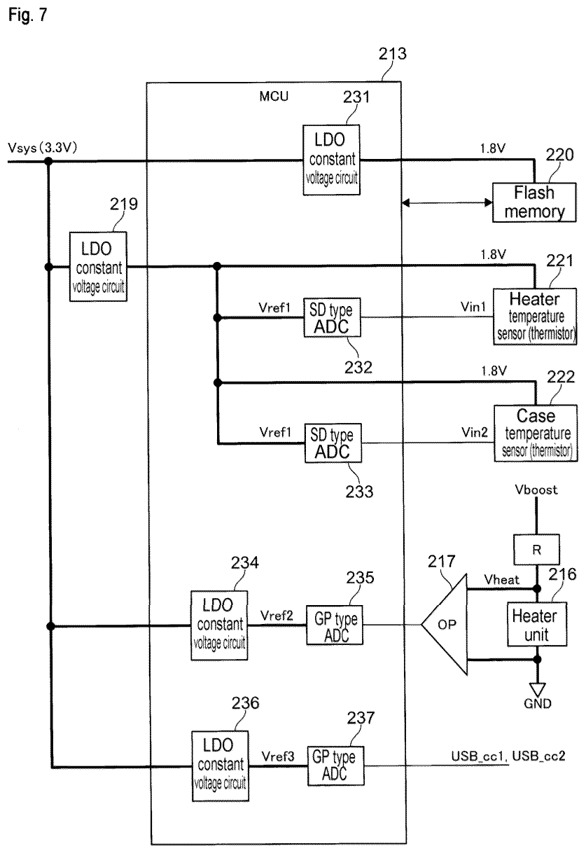

FIG. 7 is a diagram illustrating the internal configuration of the MCU 213 and connection relationships with peripheral circuits.

It should be noted that the internal configuration of the MCU 213 shown in FIG. 7 is depicted from the viewpoint of the electronic components connected to the power supply lines. It goes without saying that the MCU 213 contains various electronic components that are not depicted in FIG. 7.

There is a built-in CPU, for example. The CPU as referred to here generates control signals for the heater switch 215A (see FIG. 6) and the resistance value measurement switch 215B (see FIG. 6), for example. In addition, the MCU 213 is also provided with a switch (e.g., an FET) that controls the LEDs 20A on/off (see FIG. 6).

The MCU 213 shown in FIG. 7 is provided with an LDO constant voltage circuit 231, sigma-delta (SD) type ADCs 232 and 233, LDO constant voltage circuits 234 and 236, and general purpose (GP) type ADCs 235 and 237. However, the LDO constant voltage circuit 234 and the LDO constant voltage circuit 236 may be shared.

Among these, the LDO constant voltage circuits 231, 234 and 236 are circuits that generate a constant voltage, and the sigma-delta (SD) type ADCs 232 and 233 and the general purpose (GP) type ADCs 235 and 237 are circuits that generate data required for the processing performed by the CPU described above.

As described above, the heater temperature sensor 221 and the case temperature sensor 222 are temperature sensors that are used from the viewpoint of safety. For this reason, the AD conversion circuits that convert the output voltages from this type of temperature sensor into digital data are required to have a high conversion accuracy.

In this embodiment, the SD type ADCs 232 and 233, which have a high conversion accuracy, are used to convert the output voltages Vin1 and Vin2 of the heater temperature sensor 221 and the case temperature sensor 222. The SD type ADCs 232 and 233 as referred to here are examples of the first AD conversion circuit that converts the output voltage of the first temperature sensor into digital data.

Meanwhile, the temperature of the heater unit 216 is measured for heating control based on the heating profile. For this reason, real-time conversion of the output voltage representing the resistance value that varies in accordance with the temperature of the heater unit 216 is required. In this embodiment, the GP type ADC 235, which has a high conversion speed, is used to convert the output voltage of the operational amplifier 217.

A successive approximation ADC or a pipeline type ADC, for example, is used as the GP type ADC 235. The GP type ADC 235 as referred to here is an example of the second AD conversion circuit that converts the output voltage of the second temperature sensor into digital data. The GP type ADC 237, which has a larger input voltage fluctuation range than the SD type ADC 232, etc., is used to convert potentials apparent at the cc terminal of the USB cable.

The LDO constant voltage circuit 231 is a power supply circuit that generates a 1.8 V power supply from the system power supply Vsys. In this embodiment, the 1.8 V power supply generated by the LDO constant voltage circuit 231 is supplied only to the flash memory 220. That is, the LDO constant voltage circuit 231 is a power supply circuit dedicated to the flash memory 220.

It should be noted that, although in FIG. 7 the LDO constant voltage circuit 231 is built into the MCU 213, it may equally be provided outside the MCU 213.

In addition, in FIG. 7, the signal lines used by the MCU 213 to write digital data to the flash memory 220 and to read digital data from the flash memory 220 are represented by two-way arrows.

The LDO constant voltage circuit 231 as referred to here is an example of the second constant voltage circuit.

The LDO constant voltage circuit 219 is also a power supply circuit that generates a 1.8 V power supply from the system power supply Vsys. Moreover, the LDO constant voltage circuit 219 as referred to here is an example of the first constant voltage circuit.

The 1.8 V power supply generated by the LDO constant voltage circuit 219 is provided to the heater temperature sensor 221, the case temperature sensor 222, and the SD type ADCs 232 and 233 via a power supply line different from that of the LDO constant voltage circuit 231.

As shown in FIG. 7, the power supply line used to supply 1.8 V power to the LDO constant voltage circuit 231 and the power supply line used to supply 1.8 V power to the LDO constant voltage circuit 219 are different.

Therefore, even if the potential of the 1.8 V power supply that supplies drive power to the flash memory 220 fluctuates as the flash memory 220 operates, the fluctuations will not spread to the potential of the 1.8 V power supply supplied by the LDO constant voltage circuit 219. Thus, even if the flash memory 220 is operating, the conversion accuracy of the SD type ADC 232 and the SD type ADC 233 does not decrease.

In FIG. 7, the 1.8 V power supply generated by the LDO constant voltage circuit 219 is provided to the heater temperature sensor 221 and the SD type ADC 232 through a common power supply line. That is, the 1.8 V power supply is provided to the heater temperature sensor 221 as an operating power supply, and is provided to the SD type ADC 232 as a reference voltage Vref1.

Therefore, even if the potential of the power supply line to which the heater temperature sensor 221 and the SD type ADC 232 are connected fluctuates due to superimposed noise, the fluctuations in the 1.8 V power supply supplied to the heater temperature sensor 221 and the fluctuations in the 1.8 V power supply (reference voltage Vref1) supplied to the SD type ADC 232 change in-phase. Therefore, the influence of the fluctuations on the power supply potential is canceled out.

Therefore, the conversion accuracy of the SD type ADC 232 is not reduced. It should be noted that the converted output of the SD type ADC 232 is output to a CPU (not shown).

Similarly, the 1.8 V power supply generated by the LDO constant voltage circuit 219 is provided to the case temperature sensor 222 and the SD type ADC 233 through a common power supply line. That is, the 1.8 V power supply is provided to the case temperature sensor 222 as an operating power supply, and is provided to the SD type ADC 233 as the reference voltage Vref1.

Therefore, even if the potential of the power supply line to which the case temperature sensor 222 and the SD type ADC 233 are connected fluctuates due to superimposed noise, the fluctuations in the 1.8 V power supply supplied to the case temperature sensor 222 and the fluctuations in the 1.8 V power supply (reference voltage Vref1) supplied to the SD type ADC 233 change in-phase. Therefore, the influence of the fluctuations on the power supply potential is canceled out. Accordingly, the conversion accuracy of the SD type ADC 233 is not reduced. The converted output of the SD type ADC 233 is also output to the CPU (not shown).

It should be noted that, although in FIG. 7 the LDO constant voltage circuit 219 is provided outside the MCU 213, it may equally be provided inside the MCU 213.

In addition, the LDO constant voltage circuit 234 that generates an operating power supply Vref2 having a constant voltage from the system power supply Vsys, and the LDO constant voltage circuit 236 that generates an operating power supply Vref3 having a constant voltage from the system power supply Vsys are provided in the MCU 213.

The operating power supplies Vref2 and Vref3 as referred to here may, for example, be 1.8 V power supplies. In FIG. 7, they are denoted as the operating power supplies Vref2 and Vref3 on the assumption that they are not 1.8 V power supplies. Moreover, the operating power supply Vref2 and the operating power supply Vref3 may have the same potential or different potentials.

### Advantageous Effects

In the aerosol-generating device 1 according to this embodiment (see FIG. 1), the SD type ADCs 232 and 233 that convert the output voltages of the temperature sensors, which are provided from the viewpoint of safety, into digital data employ ADCs that have a higher conversion accuracy than the GP type ADC 235 that converts the output voltage of the heater unit 216 into digital data. Meanwhile, the GP type ADC 235 that converts the output voltage of the heater unit 216 into digital data employs an ADC that has a faster conversion speed than the SD type ADCs 232 and 233 that convert the output voltages of the temperature sensors, which are provided from the viewpoint of safety, into digital data.

It is therefore possible to provide an aerosol-generating device having both a high speed of controlling the temperature of the heating unit 207 and a high accuracy of detecting the temperature of the measurement sites.

Furthermore, in the aerosol-generating device 1 according to this embodiment, the reference voltage Vref1 of the SD type ADC 232 is also supplied to the heater temperature sensor 221 as an operating power supply. The reference voltage Vref1 of the SD type ADC 233 is also supplied to the case temperature sensor 222 as an operating power supply.

Therefore, even if the potential of the operating power supply (or the reference voltage Vref1) fluctuates, the influence of the fluctuation in potential can be canceled out, thereby improving the conversion accuracy of the ADC. That is, the accuracy of temperature measurement can be improved.

### Other embodiments

(1) Embodiments of the present disclosure were described above, but the technical scope of the present disclosure is not limited to the scope disclosed in the embodiments above. It will be obvious from the disclosure of the claims that the technical scope of the present disclosure also includes various modifications or improvements made to the embodiment above.

(2) In the embodiment described above, a case was described in which a change in the temperature of the heater unit 216 was measured, but a change in the temperature of the stick-type substrate 40 may equally be measured. In other words, a change in the temperature of the aerosol source may be measured. The change in the temperature of the aerosol source may be measured, for example, by way of a temperature sensor provided in the bottom portion 209C of the holding portion 209 (see FIG. 4). Alternatively, the change in the temperature of the aerosol source may be measured indirectly by way of the voltage Vheat appearing at the heater unit 216.

(3) In the embodiment described above, the SD type ADCs 232 and 233 were given as examples of electronic circuits for preparing constant voltage circuits separate from the constant voltage circuit supplying an operating power supply to the flash memory 220, even if operating at the same potential as the flash memory 220, but this type of electronic circuit is not limited to the SD type ADCs 232 and 233. For example, this type of electronic circuit may include an AD conversion circuit (not shown) used to measure the temperature around the secondary battery.

(4) In the embodiment described above, the SD type ADCs 232 and 233 having a high conversion accuracy were given as examples of AD conversion circuits for preparing constant voltage circuits separate from the constant voltage circuit supplying an operating power supply to the flash memory 220, even if operating at the same potential as the flash memory 220, but they may equally be the GP type ADCs 235 and 237 that have a high conversion speed.

(5) The embodiment above described a case in which the aerosol source is a solid, but the aerosol source may equally be a liquid. When the aerosol source is a liquid, a system is adopted in which the aerosol source is guided to a narrow tube known as a wick by using the capillary phenomenon, and the aerosol source is vaporized by heating a coil wound around the wick.

It should be noted that if the aerosol source is a liquid, the aerosol source is heated in conjunction with inhalation by the user.

That is to say, the liquid aerosol source is heated when the sensor unit 202 (see FIG. 4) senses inhalation by the user. However, an upper limit (e.g., 2.5 seconds) is provided for the length of heating time for one inhalation, and even if inhalation continues beyond the upper limit, heating of the aerosol source is stopped at the time when the upper limit is reached.

It should be noted that the amount of power required to heat a liquid aerosol source is less than that for a solid aerosol source.

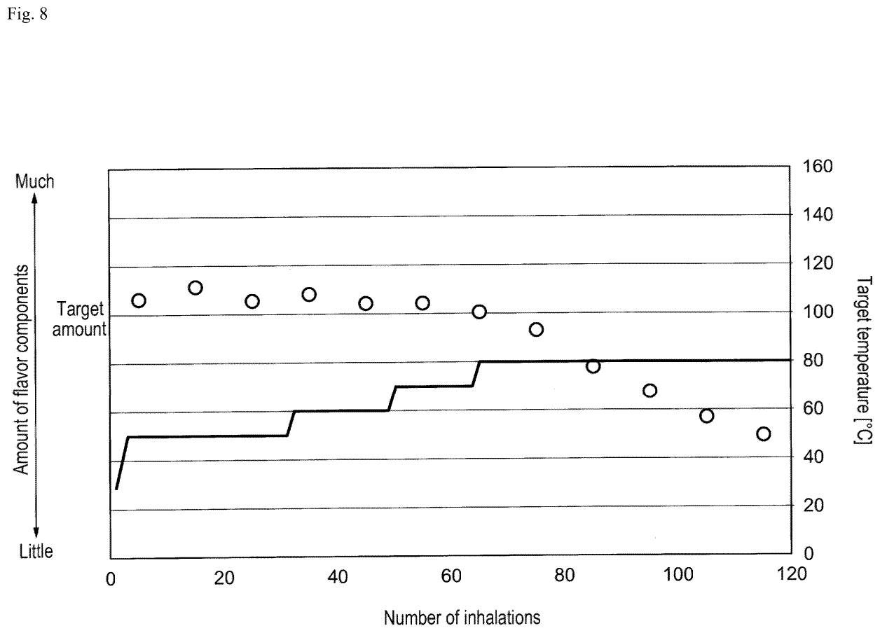

FIG. 8 is a diagram illustrating an example of a heating profile for use when the aerosol source is a liquid. In FIG. 8, the horizontal axis represents the number of inhalations. The left vertical axis indicates the amount of flavor components, and the right vertical axis indicates the target temperature. Moreover, the multiple circles shown in the drawing indicate measurement results of the amount of flavor components according to the number of inhalations, and the line graph indicates the target temperature of the heating unit 207 for causing the amount of flavor components to converge to a target amount.

(6) The embodiment above described an aerosol-generating device which generates an aerosol by heating a solid aerosol source, but the aerosol-generating device may equally generate an aerosol by separately heating each of a solid aerosol source and a liquid aerosol source. An aerosol-generating device of this type is also referred to as a hybrid aerosol-generating device.

### SUMMARY

It should be noted that the present disclosure includes the following features.

(1) An aerosol-generating device comprising a heating unit for heating an aerosol source, a first temperature sensor for measuring a temperature change at a measurement site associated with the heating by the heating unit, a first AD conversion circuit for converting an output voltage of the first temperature sensor into digital data, a second temperature sensor for measuring a temperature change of the heating unit, and a second AD conversion circuit for converting an output voltage of the second temperature sensor into digital data, wherein the first AD conversion circuit has a higher conversion accuracy than the second AD conversion circuit, and the second AD conversion circuit has a faster conversion speed than the first AD conversion circuit.

(2) The aerosol-generating device as disclosed in (1), wherein the first AD conversion circuit is a sigma-delta type AD conversion circuit, and the second AD conversion circuit is a successive approximation type or pipeline type AD conversion circuit.

(3) The aerosol-generating device as disclosed in (1) or (2), wherein the first temperature sensor operates with a reference voltage of the first AD conversion circuit as an operating power supply.

(4) The aerosol-generating device as disclosed in any one of (1) to (3), wherein the first temperature sensor has a non-linear temperature characteristic.

(5) The aerosol-generating device as disclosed in any one of (1) to (4), wherein the first temperature sensor measures a temperature around an enclosure or the heating unit, and the second temperature sensor measures a temperature change of the heating unit based on a control sequence.

(6) The aerosol-generating device as disclosed in any one of (1) to (4), wherein the first temperature sensor measures a temperature around an enclosure or the heating unit, and the second temperature sensor measures a temperature of the aerosol source.

(7) The aerosol-generating device as disclosed in any one of (1) to (6), including a first constant voltage circuit for generating a reference voltage for the first AD conversion circuit, and a second constant voltage circuit for generating an operating power supply for a memory that records an operation log, wherein the potential of the operating power supply of the memory and the potential of the reference voltage are the same.

(8) The aerosol-generating device as disclosed in any one of (1) to (6), wherein the aerosol source is a solid.

(9) The aerosol-generating device as disclosed in any one of (1) to (6), wherein the aerosol source is a liquid.

### REFERENCE SIGNS LIST

1 . . . Aerosol-generating device, 10 . . . Front panel, 10A . . . Window, 20 . . . Main body device, 20A . . . LED, 20B . . . Power button, 20C . . . Magnet, 21 . . . USB connector, 30 . . . Shutter, 40 . . . Stick-type substrate, 40A . . . Substrate portion, 40B . . . Mouthpiece portion, 201 . . . Power source unit, 202 . . . Sensor unit, 203 . . . Notification unit, 204 . . . Memory unit, 205 . . . Communication unit, 206 . . . Control unit, 207 . . . Heating unit, 208 . . . Heat insulating portion, 209 . . . Holding portion, 209A . . . Internal space, 209B . . . Opening, 209C . . . Bottom portion, 212 . . . Step-up/step-down DC/DC circuit, 213 . . . MCU, 214 . . . Step-up DC/DC circuit, 215A . . . Heater switch, 215B . . . Resistance value measurement switch, 216 . . . Heater unit, 217 . . . Operational amplifier, 219, 231, 234, 236 . . . LDO constant voltage circuit, 220 . . . Flash memory, 221 . . . Heater temperature sensor, 222 . . . Case temperature sensor, 232, 233 . . . SD type ADC, 235, 237 . . . GP type ADC

1.-9. (canceled)

10. An aerosol-generating device comprising:
a heater configured to heat an aerosol source;
a first temperature sensor configured to measure a temperature at a measurement site associated with heating by the heater;
a first analog-to-digital (AD) conversion circuit configured to convert an output voltage of the first temperature sensor into digital data;
a second temperature sensor configured to measure a temperature of the heater; and
a second analog-to-digital (AD) conversion circuit configured to convert an output voltage of the second temperature sensor into digital data, wherein
the first AD conversion circuit is configured to have a higher conversion accuracy than the second AD conversion circuit, and
the second AD conversion circuit is configured to have a faster conversion speed than the first AD conversion circuit.

11. The aerosol-generating device according to claim 10, wherein
the first AD conversion circuit is a sigma-delta type AD conversion circuit, and
the second AD conversion circuit is a successive approximation type AD conversion circuit or a pipeline type AD conversion circuit.

12. The aerosol-generating device according to claim 10, wherein the first temperature sensor is configured to operate using a reference voltage of the first AD conversion circuit as a sensor operating power supply.

13. The aerosol-generating device according to claim 10, wherein the first temperature sensor has a non-linear temperature characteristic.

14. The aerosol-generating device according to claim 10, wherein the first temperature sensor comprises a thermistor.

15. The aerosol-generating device according to claim 10, wherein the measurement site is located on a surface of an enclosure of the aerosol-generating device or around the heater.

16. The aerosol-generating device according to claim 10, further comprising:
a first constant voltage circuit configured to generate a reference voltage for the first AD conversion circuit;
a memory configured to record an operation log; and
a second constant voltage circuit configured to generate an operating power supply for the memory, wherein
a potential of the operating power supply of the memory and a potential of the reference voltage are the same.

17. The aerosol-generating device according to claim 16, wherein the first constant voltage circuit and the second constant voltage circuit are low dropout (LDO) constant voltage circuits.

18. The aerosol-generating device according to claim 10, further comprising:
an operational amplifier configured to detect a resistance value of the heater, wherein
the operational amplifier outputs the output voltage of the second temperature sensor to the second AD conversion circuit.

19. The aerosol-generating device according to claim 10, further comprising:
circuitry configured to stop heating by the heater when the output voltage of the first temperature sensor exceeds a threshold.

20. The aerosol-generating device according to claim 10, further comprising:
a heater switch configured to control application of power to the heater, wherein
the heater switch is controlled by Pulse Width Modulation (PWM).

21. The aerosol-generating device according to claim 10, wherein the aerosol source is a solid.

22. The aerosol-generating device according to claim 10, wherein the aerosol source is a liquid.

23. The aerosol-generating device according to claim 10, further comprising:
a Universal Serial Bus (USB) connector configured to receive external power; and
a charging circuit configured to switch a power supply path based on a connection state of the USB connector.

24. The aerosol-generating device according to claim 10, wherein the second temperature sensor is configured to measure a temperature change of the heater based on a control sequence.

25. The aerosol-generating device according to claim 10, wherein the first temperature sensor is provided to sense abnormal heat generation.

26. An aerosol-generating device comprising:
a heater;
a first temperature sensor;
a sigma-delta type analog-to-digital (AD) conversion circuit configured to convert a signal from the first temperature sensor;
a second temperature sensor;
a general-purpose type AD conversion circuit configured to convert a signal from the second temperature sensor; and
circuitry configured to control the heater, wherein
the sigma-delta type AD conversion circuit has a higher conversion accuracy than the general-purpose type AD conversion circuit, and
the general-purpose type AD conversion circuit has a faster conversion speed than the sigma-delta type AD conversion circuit.

27. The aerosol-generating device according to claim 26, wherein the general-purpose type AD conversion circuit is a successive approximation type AD conversion circuit.

28. The aerosol-generating device according to claim 26, further comprising:
a system power supply line; and
a low dropout (LDO) constant voltage circuit connected to the system power supply line and configured to output a reference voltage to the sigma-delta type AD conversion circuit.

29. An aerosol-generating device comprising:
a heater configured to heat an aerosol source;
a thermistor configured to measure a temperature of an enclosure of the aerosol-generating device;
a sigma-delta type analog-to-digital (AD) conversion circuit configured to convert an output of the thermistor;
an operational amplifier configured to output a voltage representing a resistance value of the heater;
a successive approximation type AD conversion circuit configured to convert the voltage output by the operational amplifier; and
circuitry configured to control power supplied to the heater based on data from the successive approximation type AD conversion circuit and to monitor the temperature of the enclosure based on data from the sigma-delta type AD conversion circuit.
